(19) United States
(12) Patent Application Publication
(10) Pub. No.: US 2026/0288699 A1
(43) Pub. Date: Sep. 24, 2026

(54) SYSTEMS AND METHODS FOR EVENT DETECTION THROUGH DATA ANOMALY IDENTIFICATION AND LLM RETRIEVAL

(71) Applicant: Expedia, Inc., Seattle, WA (US)

(72) Inventors: Michal Kuzba, Annemasse (FR); Matteo Bastiani, Geneva (CH); Eric Bruno, Veyrier du Lac (FR)

(73) Assignee: Expedia, Inc., Seattle, WA (US)

(21) Appl. No.: 19/087,058

(22) Filed: Mar. 21, 2025

(51) Int. Cl. G06F 16/23

(52) U.S. Cl. CPC G06F 16/2365

(57) ABSTRACT

A system includes one or more processors to: receive data from a plurality of sources, aggregate the received data, detect one or more anomalies in the aggregated data set by analyzing the aggregated data set by applying a filter that identifies data values within the data set that deviate by more than a predefined value from a representative data value of the aggregated data set, isolate the one or more anomalies to a particular time frame within a predefined time period and a predefined geographic region, query a machine learning model by formulating a prompt including the particular time frame and the predefined geographic region, receive at least one basis for the one or more anomalies based on the prompt, validate the at least one basis, and notify a user regarding the at least one basis via a client application associated with the system operating a device of the user.

### TECHNICAL FIELD

Embodiments and aspects of the present disclosure relate generally to systems and methods for event detection through big data anomaly identification.

### BACKGROUND

Analyses of large datasets can provide insights on the effects of different events on consumers. As an example, various events in a geographic area may affect different aspects of travel, particularly booking lodging. However, data sets are large and non-uniform. Thus, it is challenging to aggregate data from disparate sources and then identify anomalies in the aggregated data sets.

### SUMMARY

At least one aspect relates to a system for detecting and identifying data anomalies. The system includes at least one processing circuit including one or more processors coupled to one or more memory devices. The at least one processing circuit may be configured to: receive data from a plurality of sources regarding a predefined geographic region and for a first predefined time period; aggregate the received data to form an aggregated data set; detect one or more anomalies in the aggregated data set by analyzing the aggregated data set by applying a filter that identifies data values within the data set that deviate by more than a predefined value from a representative data value of the aggregated data set; isolate the one or more anomalies to a particular time frame within the predefined time period and the predefined geographic region; query a machine learning model by formulating a prompt comprising the particular time frame and the predefined geographic region; receive, from the machine learning model, at least one basis for the one or more anomalies based on the prompt; validate the at least one basis; and notify a user regarding the at least one basis via a client application associated with a system operating a device of the user.

Another embodiment relates to a method for detecting and identifying data anomalies. The method includes receiving, by one or more processors, data from a plurality of sources regarding a predefined geographic region and for a first predefined time period; aggregating, by the one or more processors, the received data to form an aggregated data set; detecting, by the one or more processors, one or more anomalies in the aggregated data set by analyzing the aggregated data set by applying a filter that identifies data values within the data set that deviate by more than a predefined value from a representative data value of the aggregated data set; isolating, by the one or more processors, the one or more anomalies to a particular time frame within the predefined time period and the predefined geographic region; querying, by the one or more processors, a machine learning model by formulating a prompt comprising the particular time frame and the predefined geographic region; receiving, by the one or more processors, from the machine learning model, at least one basis for the one or more anomalies based on the prompt; validating, by the one or more processors, the at least one basis; and notifying, by the one or more processors, a user regarding the at least one basis via a client application associated with a system operating a device of the user.

Still another aspect relates to one or more non-transitory computer-readable media storing instructions thereon that, when executed by one or more processors, cause the one or more processors to perform operations including: receiving data from a plurality of sources regarding a predefined geographic region and for a first predefined time period; aggregating the received data to form an aggregated data set; detecting one or more anomalies in the aggregated data set by analyzing the aggregated data set by applying a filter that identifies data values within the data set that deviate by more than a predefined value from a representative data value of the aggregated data set; isolating the one or more anomalies to a particular time frame within the predefined time period and the predefined geographic region; querying a machine learning model by formulating a prompt comprising the particular time frame and the predefined geographic region; receiving, from the machine learning model, at least one basis for the one or more anomalies based on the prompt, validate the at least one basis; and notifying a user regarding the at least one basis via a client application associated with a system operating a device of the user.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 depicts a block diagram of a system for identifying events causing data anomalies, according to an example embodiment.

FIG. 2 depicts a block diagram of the event detector circuit of the system of FIG. 1, according to an example embodiment.

FIG. 3 depicts a flow diagram of a method of data anomaly detection, according to an example embodiment.

FIG. 4 depicts a graph for detecting anomalies indicative of one or more events, according to an example embodiment.

FIG. 5 depicts a flow diagram of a method of event detection via data anomaly identification, according to an example embodiment.

### DETAILED DESCRIPTION

Following herein below are systems, methods, and computer-readable media for detecting anomalies in certain data sets and using the detected anomalies to identify one or more events associated with the detected or determined anomalies.

It is difficult for both humans and conventional computing systems to analyze large datasets. Analyzing large data sets may result in increased computing power and reduced processing speeds. Further, identification of anomalous data within large data sets may be difficult. Humans and/or current computing systems may be unable to identify meaningful anomalies within a large data set. Additionally, it may be difficult to identify a cause of the anomalies within the data.

The systems, methods, and computer-readable media described herein provide a manner of reducing an amount of data analyzed, thereby reducing computing power and increasing processing speeds. Specifically, data is aggregated from a plurality of sources and filtered according to various parameters before and/or during analysis. For example, data may be received from a plurality of sources, and is filtered such that data pertaining to a particular, predefined geographic region and/or predefined time period is analyzed. Accordingly, only relevant data may be analyzed to detected anomalies. As described herein, the systems, methods, and computer-readable media described herein may identify anomalies within the aggregated data set to identify a particular event that causes the one or more anomaly data points. Such data points may be indicative of one or more events of interest occurring within a time period during which the anomalous data point was collected. These datasets may include a large number of data points collected during a large number of time periods. For example, a dataset may include thousands of data points representing data collected from a variety of sources within a single time period (e.g., one day). The data set may include day-by-day information collected over a long period of time (e.g., months, years, decades, etc.). Thus, the systems, methods, and computer-readable media described provide a technical solution to at least big data analysis.

Further, the systems, methods, and computer-readable media described herein implement the use of one or more models, such as large language model (LLM), to identify the events causing the anomalies. The LLM(s) may utilize pattern recognition and other techniques to identify anomalies within the data set, particularly anomalies that may result from a particular event. Humans, and current computing methods, may have reduced pattern recognition, and therefore anomaly detection in comparison to the systems, methods, and computer readable media described herein.

The systems, computer-readable media, and methods described herein utilize data from a plurality of providers to detect events that may or will be occurring in a particular area. Specifically, the systems, computer-readable media, and methods described herein may identify anomalies in the data. An anomaly may be a data point (or a predefined number of data points) that deviates from a metric regarding the data points (e.g., an average value) by more than a predefined amount. As an example, the systems and methods may identify anomalies in price data from a plurality of lodging providers in a geographical area to detect events occurring in the area that are responsible for the anomalous prices. Upon detecting an anomaly, the system may retrieve, using, for example, a large language mode (LLM), a list of events occurring in the area. The system may cross-reference the detected anomalies with the list of events to identify which event may be causing the anomaly. The system can perform a variety of operations upon detecting the event causing the anomaly. For example, the system can adjust data value parameters based on the identified event.

As a particular example, events, such as concerts, sporting events, festivals, etc., may affect lodging for travelers and/or lodging providers. For example, events occurring in an area may affect booking patterns, demand shares of different lodging providers, etc. Lodging prices may therefore be adjusted according to a magnitude of an event, a distance of the lodging venue from the event, etc. The system can also notify travelers booking lodging that a particular lodging parameter (e.g., price) is affected by the event. Further, the system can notify other lodging providers, such as vacation rental hosts, that an event is occurring and it may be beneficial to adjust a lodging parameter.

Additionally, a multi-pass anomaly detection process may be used to improve data analysis. That is, the system may first detect one or more anomalous data points that may overly impact data trends, and subsequently remove at least one anomaly from the dataset. A second anomaly detection is performed that identifies additional one or more anomalies and correlates the additional one or more anomalies to events impacting lodging parameters. Detection of major anomalies during a first pass may improve functioning of the models used to generate trend data used to identify the events. For example, removal of major anomalies may cause the generated trend to be less influenced by the anomalous data, thereby preventing the system from overestimating lodging parameters in similar periods where the anomaly is not occurring. These and other features and benefits are described more fully herein below.

Before turning to the Figures, which illustrate certain example embodiments in detail, it should be understood that the present disclosure is not limited to the details or methodology set forth in the description or illustrated in the Figures. It should also be understood that the terminology used herein is for the purpose of description only and should not be regarded as limiting.

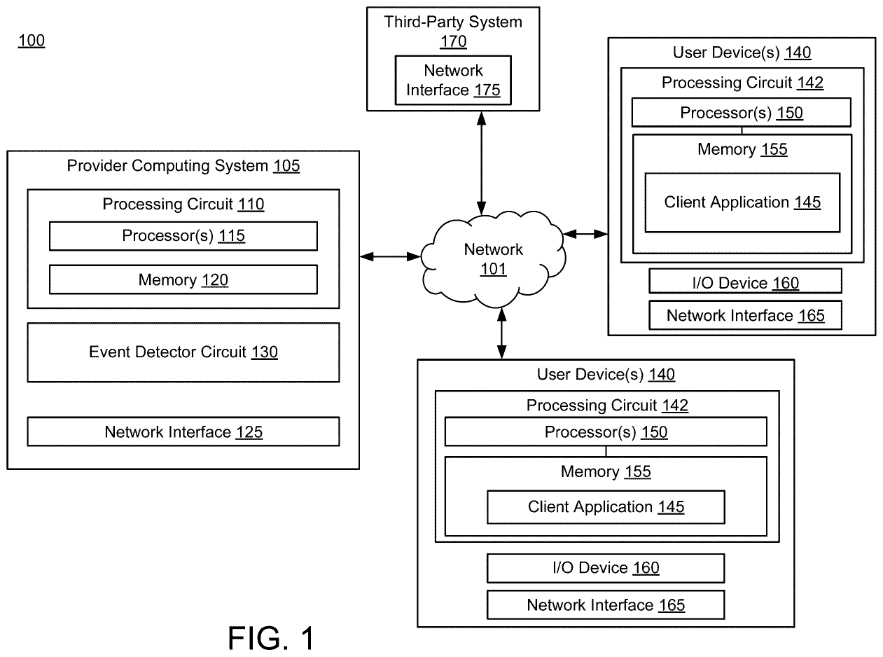

FIG. 1 illustrates an example system 100 for detecting and identifying data anomalies, according to an example embodiment. As will be discussed herein, provider computing system may identify one or more events causing anomalies in data associated with one or more locations (e.g., lodging venues) within a geographical area (e.g., a city, town, state, etc.). As described herein, the systems and methods described herein may be utilized with travel-related uses, such as using lodging venues, but can also be applied to identifying events based on identifying anomalies in any type of data (e.g., anomalies in weather data, etc.).

According to some embodiments and as shown, the system 100 includes a provider computing system 105 coupled to one or more user devices 140 and one or more third-party systems 170 via a network 101. The provider computing system 105 may be a computing system associated with a provider entity. The provider organization or entity may be a provider of goods and/or services (e.g., an online travel agency). In this example, the provider entity is a travel services/experiences provider, such as a travel agency or travel broker (e.g., a company that allows users to book travel services provided by other companies), which provides and maintains one or more accounts on behalf of the user. The provider may be a transportation provider (e.g., airline, car or rental vehicle service, rideshare/taxi service etc.), a lodging provider (e.g., hotel, rental property, cruise, etc.), an experience provider (e.g., theme parks, concerts, shows, events, excursions, etc.), or any combination thereof. In the example shown, the provider is a travel or experience booking agency that provides or enables a variety of experiences by interfacing/communicating with other providers (e.g., lodging providers, airline providers, etc.). As described herein, in some implementations, provider computing system 105 may be structured or configured to identify events causing data anomalies in certain data, such as travel data (e.g., lodging booking data, lodging price data, etc.).

The provider computing system 105 can include at least one processing circuit 110, which may, as an example, include at least one processor 115 and at least one memory 120. The provider computing system 105 may include one or more servers that include one or more of the processors and/or memory components described above and herein. The memory 120 can store computer-executable instructions that, when executed by the processor 115, cause the processor 115 to perform one or more of the operations described herein. The processor 115 may include a microprocessor, an application-specific integrated circuit (ASIC), a field-programmable gate array (FPGA), a graphics processing unit (GPU), a tensor processing unit (TPU), etc., and/or combinations thereof. The memory 120 may include, but is not limited to, electronic, optical, magnetic, or any other storage or transmission device capable of providing the processor 115 with program instructions. The memory 120 may further include a magnetic disk, memory chip, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The provider computing system 105 can include one or more computing devices or servers that can perform various of the operations or functions described herein. The memory 120 may store an event detector circuit 130, which will be described in greater detail herein.

The provider computing system 105 can be structured as one or more backend computing systems including one or more servers and other computing components, in some embodiments. The provider computing system 105 (e.g., the memory 120) may include an event detector circuit or processing circuit 110 that is configured to identify one or more events causing or associated with an anomaly in received, integrated, and analyzed data.

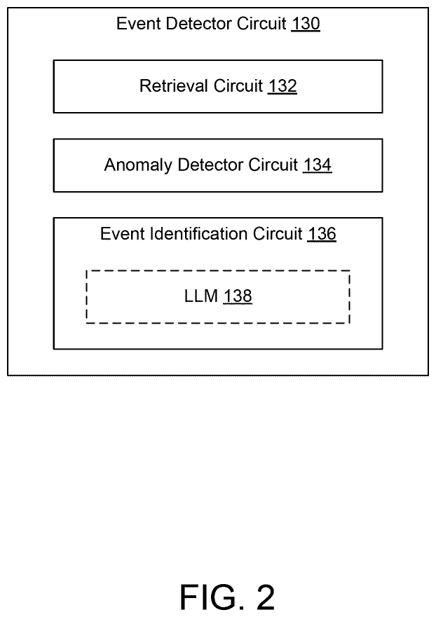

In some implementations, various components and/or systems of the system 100 may be configured to identify events causing anomalies in pricing data for a plurality of venues (e.g., hotels) in a geographic area. However, it should be understood that the systems and methods described herein are not limited to identifying events using anomalies in price data, but can be used to identify events using anomalies in other data, bookings (e.g., a number of bookings), impressions (e.g., a number of impressions), etc. As an example, the data may include price data for a plurality of lodging providers in a geographic region. The event detector circuit 130 may identified anomalous price data that indicates that an event is occurring in the geographic region. The event detector circuit 130 may query the machine learning model to retrieve a list of events occurring in the geographic region. The event detector circuit 130 may then compare the retrieved list of events to the detected anomaly. Based on a match between a date of an event on the list and the data where the anomaly in the price data occurs, the event detector circuit 130 identifies that the event is causing the anomaly in the data. The event detector circuit 130 will be described in greater detail with respect to FIG. 2.

The provider computing system 105 can include a network interface 125. In some instances, the network interface 125 includes, for example, program logic and any associated hardware components (e.g., transceivers, ethernet cards, etc.) that couple the provider computing system 105 to the network 101. The network interface 125 may facilitate secure communications between the provider computing system 105 and each of the user device(s) 140 and third-party system(s) 170 (e.g., by using one or more encryption techniques to shield communications). The network interface 125 also facilitates communication with other entities, such as other providers of goods and/or services (e.g., airline computing systems, lodging computing systems, music event computing systems that are associated with concert arenas, etc.).

The network 101 can include any combination of wired and/or wireless networks. Thus, the network 101 may include packet-switching computer networks such as the Internet, local, wide, metro, or other area networks, intranets, satellite networks, other computer networks such as voice or data mobile phone communication networks, or combinations thereof. The provider computing system 105 of the system 100 can communicate via the network 101 with one or more computing devices, such as the one or more user devices 140 and the one or more third-party systems 170. The network 101 may be any form of computer network that can relay information between the provider computing system 105, the one or more user devices 140, the one or more third-party systems 170, and one or more information sources, such as web servers or external databases, amongst others. In some implementations, the network 101 may include the Internet and/or other types of data networks, such as a local area network (LAN), a wide area network (WAN), a cellular network, a satellite network, or other types of data networks. The network 101 may also include any number of computing devices (e.g., computers, servers, routers, network switches, etc.) that are configured to receive or transmit data within the network 101.

As alluded to above, the network 101 may include any number of hardwired or wireless connections. Any or all of the computing devices described herein (e.g., the provider computing system 105, the one or more user devices 140, the one or more third-party systems 170, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 101. Any or all of the computing devices described herein (e.g., the provider computing system 105, the one or more user devices 140, the one or more third-party systems 170, etc.) may also communicate wirelessly with the computing devices of the network 101 via a proxy device (e.g., a router, network switch, or gateway). In some embodiments, a wired or a combination of wired and/or wireless connections may be used to enable communicable coupling.

The system 100 is shown to include a plurality of user devices 140. The user device 140 may be owned by, managed by, and/or otherwise associated with a user. In the example shown whereby the provider is a travel experience provider (e.g., an online travel agency), the user may be a customer. For example, the user may be a traveler that uses the products and/or services of the provider entity. The user or traveler may be an individual, a representative of an entity, and/or another type of user. The user may view or browse a website and/or mobile application associated with the provider. Specifically, the user may be viewing the website or mobile application associated with the provider to, for example, view properties, view flight options, view experiences (e.g., concerts, bungee jumping, etc.), and book one or more experiences (e.g., book lodging, book a flight, book a show such as a sports events, etc.).

The user device 140 may be one or more computing devices that can perform various operations as described herein. For example, in some implementations, the user device 140 may be or may include, for example, a desktop or laptop computer (e.g., a tablet computer), a smartphone, a wearable device (e.g., a smartwatch), a personal digital assistant, and/or any other suitable computing device. In the example shown, the user device 140 is structured as a computing device, namely a mobile device (e.g., a smartphone).

Each of the user devices 140 can include at least one processing circuit 142, at least one processor (e.g., processor(s) 150), and at least one memory (e.g., memory 155). The memory 155 may, as an example, include at least one client application (e.g., client application 145). In some implementations, one or more of the user devices 140 can access various functions of the provider computing system 105 through the network 101. For example, the user device 140 can access one or more functions of the provider computing system 105 via the client application 145 of the user device 140 that is configured to display various user interfaces to the user device 140 via the network 101.

The client application 145 can be coupled to and supported, at least partly, by the provider computing system 105. For example, in operation, the client application 145 can be communicably coupled to the provider computing system 105 and may perform certain operations described herein. In some embodiments, the client application 145 includes program logic stored in a system memory (e.g., memory 155) of the user device 140. In such arrangements, the program logic may configure a processor (e.g., processor(s) 150) of the user device 140 to perform at least some of the functions discussed herein with respect to the client application 145 of the user device 140. In the example shown, the client application 145 may be downloaded from an application store, stored in the memory 155 of the user device 140, and selectively executed by the processor(s) 150. In other embodiments, the client application 145 may be hard-coded into the user device 140. In still various other embodiments, the client application 145 is a web-based application.

As alluded to above, the client application 145 may be provided by the provider associated with the provider computing system 105 such that the client application 145 supports at least some of the functionalities and operations described herein with respect to the provider computing system 105. In this way, the client application 145 may also be referred to as a provider institution client application or provider client application. In some embodiments, the client application 145 may be accessed and executed by the processor(s) 150 responsive to receiving various credentials of a user to access the client application 145 (e.g., a username, a password, a pin code, a biometric such as a facial scan or a fingerprint, a combination thereof, etc.).

In some instances, the client application 145 may additionally be coupled to the third-party system(s) 170 (e.g., via one or more application programming interfaces (APIs) and/or software development kits (SDKs)) to integrate one or more features or services provided by the third-party system(s) 170. In some instances, the third-party system(s) 170 may alternatively and/or additionally provide services via a separate client application 145. For example, the client application 145 may initiate an API call to the third-party system 170 to retrieve API information related to reviews for the property left on a website not associated with the provider.

The processor(s) 150 can include a microprocessor, an ASIC, an FPGA, a GPU, a TPU, etc., or combinations thereof. The memory 155 can store processor-executable instructions that, when executed by the processor(s) 150, cause the processor(s) 150 to perform one or more of the operations described herein. The memory 155 can include, but is not limited to, electronic, optical, magnetic, or any other storage or transmission device capable of providing the processor 150 with program instructions. The memory 155 can further include a memory chip, ROM, RAM, EEPROM, EPROM, flash memory, optical media, or any other suitable memory from which the processor(s) 150 can read instructions. The instructions can include code from any suitable computer programming language.

The user device 140 is further shown as including an I/O device 160 and a network interface 165. The I/O device 160 can include various components for receiving inputs, providing outputs, and/or receiving and providing inputs and outputs, respectively, to a user of the user device 140. For example, the I/O device 160 can include a display screen such as a touchscreen, a mouse, a button, a keyboard, a microphone, a speaker, an accelerometer, actuators (e.g., vibration motors), any combination thereof, etc. The I/O device 160 may also include circuitry/programming/etc. for operating such components. The I/O device 160 thereby enables communications to and from a user, for example communications relating to travel recommendations as described in further detail herein.

The network interface 165 includes, for example, program logic and various devices and/or components and systems (e.g., transceivers, etc.) that couple the user device 140 to the network 101. The network interface 165 facilitates secure communications between the user device 140 and each of the provider computing system 105 and/or the third-party system 170. The network interface 165 also facilitates communication with other entities, such as other providers of goods and/or services.

The system 100 is shown to include the third-party system 170 (although only one is shown, there could be a plurality or, in some embodiments, none). The third-party system or third-party computing system 170 may be owned by, managed by, and/or otherwise associated with a third-party or third-party entity relative to the provider. For example, the third-party entity may be or may include various goods and/or services provider entities including, but not limited to, a lodging provider (e.g., hotel, rental property, cruise, etc.), a transportation provider (e.g., airline, car service, etc.), an experience provider (e.g., theme parks, concerts, shows, events, excursions, etc.), or any combination thereof.

In the example shown, the system includes a plurality of third-party systems 170. Thus, the system 100 may include a third-party entity 170 associated with a lodging provider, another third-party entity 170 associated with a transportation provider, and another third-party computing system 170 associated with an experience provider. The provider computing system 105 may selectively receive information or data from each of the third-party systems 170. The provider computing system 105 may additionally communicate with the third-party systems 170 to make bookings, such as to reserve experiences on behalf of the traveler/user. The third-party system 170 includes a respective network interface 175 to facilitate exchanging data with the provider computing system 105 and/or the user device 140 through the network 101. The third-party system 170 may include one or more servers. The third-party system 170 may include one or more APIs and/or SDKs associated with the third-party entity for exchanging data with the provider computing system 105 and/or the user device 140, as described herein.

The provider computing system 105 is shown to include an event detector circuit 130. The event detector circuit 130 may retrieve data for a plurality of sources in a predefined geographic region for a predefined period of time. As an example, the data from each data source may be lodging pricing data. In other implementations, the data may include, for example, occupancy data (e.g., from lodging providers, businesses, etc.), emissions data, climate data, or any other type of data. The event detector circuit 130 may aggregate the data to form an aggregated data set. The event detector circuit 130 may subsequently detect one or more anomalies in the aggregated data set. Further, the event detector circuit 130 may determine a basis for each identified anomaly (e.g., a cause of the detected anomaly). As described herein and responsive to identifying the anomaly, the event detector circuit 130 may query a machine learning model and receive at least one basis for the one or more detected anomalies (e.g., based on a prompt provided to the machine learning model). The event detector circuit 130 validates the at least one basis and notifies a user regarding the at least one basis. The user may be notified via a client application (e.g., client application 145) associated with a system operating device of the user (e.g., user device 140).

Referring now to FIG. 2, a block diagram of the event detector circuit 130 is shown, according to an example embodiment. The event detector circuit 130 may identify one or more anomalies in an aggregated data set generated from data received from a plurality of data sources. For example, the event detector circuit 130 may identify one or more events in a geographic area that may be causing anomalies in data (e.g., pricing data) for one or more lodging venues (e.g., hotels) in the geographic area. For example, the event detector circuit 130 may identify that hotel prices for hotels in a city for a particular week are higher than normal (e.g., higher than a historic average for that week), and may use the identified anomalous price to identify an event causing the prices to be increased.

In other examples, the event detector circuit 130 may identify one or more events in a geographic area causing anomalies in, for example, emissions data, for one or more vehicle providers. For example, a manufacturer of a vehicle component may have produced a faulty vehicle component leading to increased emissions. The event detector circuit 130 may identify that emissions values for vehicles in a certain region (and/or from a certain manufacturer, etc.) are higher than normal (e.g., higher than a historic average) and use the identified anomalous emissions data to identify an event causing emissions values to increase (e.g., a date on which faulty components were installed in vehicles, etc.).

In another example, the event detector circuit 130 may identify one or more events in a geographic area causing anomalies in occupancy data. For example, the event detector circuit 130 may identify that occupancy rates for hotels in a geographic area are higher than normal, and may use the identified anomalous occupancy data to identify an event causing the occupancy to be increased.

In still another example, the event detector circuit 130 may identify one or more occurrences based on anomalies in aggregated data regard, for example, impressions. Impressions may be data indications regarding potential events or occurrences. For example, the event detector circuit 130 may scrape and/or receive data regarding social media feeds. The social media feeds may provide indications of occurrences in various areas, such as events. The feeds may be scraped by the circuit 132 for “likes” and/or other indications above a predefined thresholds that may then be used by the circuit 132 to determine potential occurrences. As a result of the determination of potential occurrences, the circuit 132 may provide an indication to the large language model 138 to validate the potential identification of an occurrence.

The event detector circuit 130 may include at least a retrieval system or circuit 132, an anomaly detector circuit 134 and an event identification system or circuit 136, which may include a large language model 138. In various embodiments, the systems 132-138 may not be part of the provider computing system 105 but instead may be third-party LLMs that are accessed by the provider computing system 105. As described herein, the systems 132-138 may be one or more circuits as the term “circuits” is defined herein.

The systems 132-138 may include, but are not limited to, large language models (LLMs), which are capable of processing complex input prompts and generating human-like responses and can be trained to generate human-like text, speech, images, or components of graphical user interfaces. The systems 132-138 may be structured using a deep learning architecture that includes a multitude of interconnected layers, including transformer layers, attention mechanisms, self-attention layers, and transformer blocks. The systems 132-138 are trained on large datasets to assimilate patterns, structures, and relationships within large corpuses of text data.

The LLMs (e.g., systems 132-138) may be trained to generate outputs that closely resemble the characteristics of the input data. The systems 132-138 may be fine-tuned to generate specific output data, including data that is compatible with various database architectures or augmented reality systems. The systems 132-138 can be trained via optimization of a large number of parameters, in which the systems 132-138 learn to minimize the error between its predictions and the actual data points, resulting in highly accurate and coherent generative capabilities. For example, the systems 132-138 may be trained using human, agent-generated summaries that inform future-generated summaries by the systems 132-138.

Although various implementations describe the systems 132-138 as being large language models, it should be understood that the present techniques may be implemented in connection with any type of generative model. For example, the systems 132-138 may include large language models, multimodal generative models, stable diffusion models or other diffusion-based models, generative adversarial networks (GANs), variational autoencoder models, or any other type of generative model. In some implementations, such systems 132-138 may include additional output layers or may be otherwise configured to generate output values corresponding to the various scores described herein.

In some implementations, the systems 132-138 may include any number of input layers, hidden layers, and output layers. In some implementations, one or more systems 132-138 may be or include pre-trained generative models that are fine-tuned to specific applications. For example, the output of one or more of the systems 132-138 can be controlled and guided during a fine-tuning process by introducing task-specific loss functions or constraints, which can be utilized to optimize and specify particular application-specific outputs of the systems 132-138. In some implementations, one or more of the systems 132-138 may be trained using a fine-tuning process to automatically generate outputs corresponding to the one or more scores, which may be stored, for example, as part of score data or displayed via one or more graphical user interfaces (e.g., a graphical user interface of the user device 140).

The retrieval circuit 132 may be configured to retrieve, receive, obtain, acquire, etc. data from a plurality of sources. For example, the retrieval circuit 132 may retrieve data from a plurality of third-party systems 170 associated with a plurality of third-party providers. In some embodiments, the data is retrieved from a plurality of the same type of third-party providers (e.g., all lodging providers). In other embodiments, the data is retrieved from a plurality of different types of third-party providers (e.g., lodging providers, airline providers, and experience providers). The retrieval circuit 132 may retrieve the data from the plurality of sources by, for example, initiating a plurality of application programming interface (API) calls to the plurality of sources.

For example, the retrieval circuit 132 may retrieve data from a plurality of third-party providers. As described herein, each third-party provider may provide a plurality of data points. For example, retrieval circuit 132 may retrieve, from a single third-party provider, for a certain period of time, 100 data points. In other embodiments, the data from each third-party provider may be a single, representative data point that represents all 100 pieces of data.

As a specific example, the retrieval circuit 132 may retrieve price data from a plurality of lodging providers within a geographic area. As described herein, price data may include a price per night of each room in a lodging venue. For example, one hotel may have 100 rooms. The retrieval circuit 132 may retrieve, for a certain night, 100 data points, each corresponding to a rate of a room in the hotel for that night. In other embodiments, the price data from each lodging venue may be an average price for all rooms for a certain night. For example, for a hotel having 100 rooms, the price data for a particular night may be a single price that is an average of the 100 individual rates for each hotel room on the certain night.

The retrieval circuit 132 may normalize the received data. For example, the retrieval circuit 132 may normalize the received data by converting each received piece of data to the same format (e.g., binary, JSON, CSV, TXT, PDF, etc.). The retrieval circuit 132 may then filter, categorize, sort, etc., the received data. The retrieval circuit 132 may filter the data to include only data from, for example, specific sources (e.g., third-party providers). For example, when data is received from a plurality of different types of third-party providers, the retrieval circuit 132 may filter the data so only data received from a single type of provider (e.g., only lodging providers) is shown and included in the data set. In examples where data is received from a plurality of the same type of third-party provider (e.g., multiple lodging providers), the retrieval circuit 132 may filter the data so only data received from certain providers (e.g., only hotels, only vacation rentals, only specific hotel brands, etc.) is shown and included in the data set.

In this manner, the data set used to identify anomalies may be manipulated by way of categorization, filtering, etc. Filtering the data may reduce a computing network occupancy, as only certain types of data and/or providers may be requested. Further, computing processing speeds may increase by allowing the event detector circuit 130 to analyze only certain data received from the plurality of data sources.

Responsive to sorting the data (e.g., to reduce an amount of data analyzed by the event detector circuit 130), the retrieval circuit 132 may further filter the data to identify data for a predefined time period. The predefined time period may be the time period of interest for analyzing data. The retrieved data may include data (e.g., price data) for a predefined period of time (e.g., a fixed booking window). For example, the retrieval circuit 132 may retrieve, from each provider within a predefined area, information for each day within a one-year period. The predefined time period may include past dates (e.g., the previous six months from a current date) and future dates (e.g., the future six months from the current date). Thus, the retrieved data may include historical data (e.g., data from a certain amount of time prior to a current date) and future data (e.g., data for a certain amount of time ahead of a current date). For example, the data may include data for each day of the six months prior to a current date, as well as data for each day of the six months ahead of the current date. The future data may be determined and/or preset by the third-party provider from which the data is received. For example, third-party providers may utilize predictive models to predict future data (e.g., future inventory, future prices, future occupancy, etc.).

In some embodiments, future data may be known. Known future data may relate to known parameters set and/or provided by the third-party provider, such as set inventory particular dates in the future. For example, known future data may be hotel prices and/or inventory, as a third-party provider may know which days the hotel will be operating, a number of rooms available in the future, and a price that has been set for each available room.

In other embodiments, future data may be unknown and therefore predicted (e.g., by a third-party and/or the provider computing system). Predicted data may be data corresponding to a certain period of time (e.g., a day) that changes or updates up until the period of time occurs and therefore cannot be known until the period of time has passed. For example, predicted data may be or include a final number of bookings for a hotel on a particular day, a final occupancy for a hotel on a particular day, etc. For example, a number of bookings may be predicted because customers can reserve a hotel room up to and including the date on which the customer may stay at the hotel, and a final number of bookings would not be known until the date has passed.

In various embodiments, the predefined time period may vary. For example, the retrieval circuit 132 may retrieve data for the previous year only, data for the next year only, data for the three previous months and the next nine months, etc. Further, the period of time may be longer or shorter than one year (e.g., six months, eighteen months, 180 days, etc.). In various embodiments, historical data may be retrieved from each third-party provider to train a model (e.g., the anomaly detector circuit 134) on market trends and seasonality. Historical data may further be used to identify, based on past events, price elasticity of current and/or future events.

Responsive to sorting the received data by a desired predefined time period, the retrieval circuit 132 may filter the data based on location. For example, the event detector circuit 130 may detect events occurring in a predefined geographic region or area. The retrieval circuit 132 may filter the data such that only data relevant to the predefined geographic area (e.g., data only from third-party providers located within the predefined geographic area, etc.) is included in the data set.

For example, each data set received from a different third-party provider may be transformed to include a geographical indicator associated with the source (e.g., provider). For example, upon receipt of the data, the retrieval circuit 132 may receive an indication of a location of origin of the data. The retrieval circuit 132 may transform the data to include, for example, latitude and longitude coordinates, a zip code, a neighborhood, a street name, an address, etc.

The retrieval circuit 132 may request data from each of the third-party systems 170 via, for example, at least one API call. In various embodiments, the retrieval circuit 132 may retrieve data from all of the providers within a predefined region or geographic area. The predefined region or geographic area may be received from an operator of the provider computing system 105 via one or more inputs. The event detector circuit 130 may identify and/or isolate entities (e.g., data sources, third-party providers, etc.) using the predefined region. For example, the retrieval circuit 132 may receive data from the plurality of data sources. The received data may include an indication of where the data is located or originating. For example, a response from a third-party provider to an API call from the retrieval circuit 132 may include an indication of a location of the data (e.g., coordinates, zip code, etc.). The retrieval circuit 132 may translate the received location information into an identified region. The retrieval circuit 132 may then filter the data received from all of the data sources such that only data pertaining to the predefined geographical region is included in the aggregated data set.

For example, the event detector circuit 130 may be configured to identify events occurring in Seattle, Washington. As such, to identify the events, the event detector circuit 130 may retrieve data from all lodging providers (e.g., hotels, motels, etc.) within a certain distance from a center point of the city (e.g., within a fifteen mile distance of the Seattle city center). In some embodiments, the retrieval circuit 132 may retrieve data from lodging providers located outside of an area in which an event is to be detected. For example, when an event is occurring in a city center, travelers may stay outside of the city center. As such, when the event detector circuit 130 is configured to identify an event occurring within a predefined distance (e.g., ten miles) of a city center, the retrieval circuit 132 may be configured to retrieve data from lodging providers within a distance greater than the predefined distance (e.g., fifteen miles) of the city center. In various embodiments, the retrieval circuit 132 may retrieve data in real-time to reflect updated or changing data values (e.g., lodging prices) set or modified by providers.

In various embodiments, the retrieval circuit 132 may be configured to retrieve data from a subset of providers within the geographic area. For example, price data for a five star hotel may be different than price data for a one star hotel over the same time period. As such, in some embodiments, the retrieval circuit 132 may retrieve price data for lodging that meets certain criteria or have certain features (e.g., is above or below a certain rating value, etc.). As will be described herein, this may avoid skewed or inaccurate data when the anomaly detector circuit 134 aggregates the retrieved price data.

The anomaly detector circuit 134 may be configured to aggregate and analyze the data retrieved by the retrieval circuit 132 to form an aggregated data set. For example, the retrieval circuit 132 may transmit the retrieved data to the anomaly detector circuit 134. Upon receipt of the data, the anomaly detector circuit 134 may aggregate the data. The anomaly detector circuit 134 may aggregate the data by determining (e.g., calculating), for each day in the period of time the data spans, a representative value of the received, obtained, and/or collected data points (e.g., an average value, a median value, another representative value such as a high or low value, etc.). In one embodiment, the representative value is an average value. The average value may be calculated by determining an arithmetic mean of the data points (e.g., the anomaly detector circuit 134 may sum all data points and divide by the number of data points to determine the average value). For example, the anomaly detector circuit 134 may aggregate price data from 50 hotels in Seattle, WA from a period of January 1 to December 31. The price data from each hotel may be in the form of a single, average room price per night. Thus, the price data received from each hotel may include 365 individual data points (e.g., one average price of a room per night in the January 1 to December 31 time period). As an example, to determine the average price (e.g., market price) of a hotel room in Seattle, WA on January 1, the anomaly detector may sum the 50 received price values for January 1 from each of the 50 hotels, and divide the sum by 50 to determine the average price. This process may be repeated for the remaining 364 days' worth of data points.

In embodiments in which the price data is received from each hotel as data for each room in the hotel per night, the anomaly detector may first aggregate the price data per night for a particular hotel. For example, for a hotel with 100 rooms, the retrieval circuit 132 may receive 100 data points (e.g., prices) for each night in a 365 day time period. The anomaly detector circuit 134 may, for each night, sum the 100 data points and divide by 100 to determine an average price per night of any room in the hotel. The average price per night value may be used in conjunction with price data from each of the other hotels to determine a market average per night across all hotels in the identified geographic area (e.g., across all hotels from which data was received).

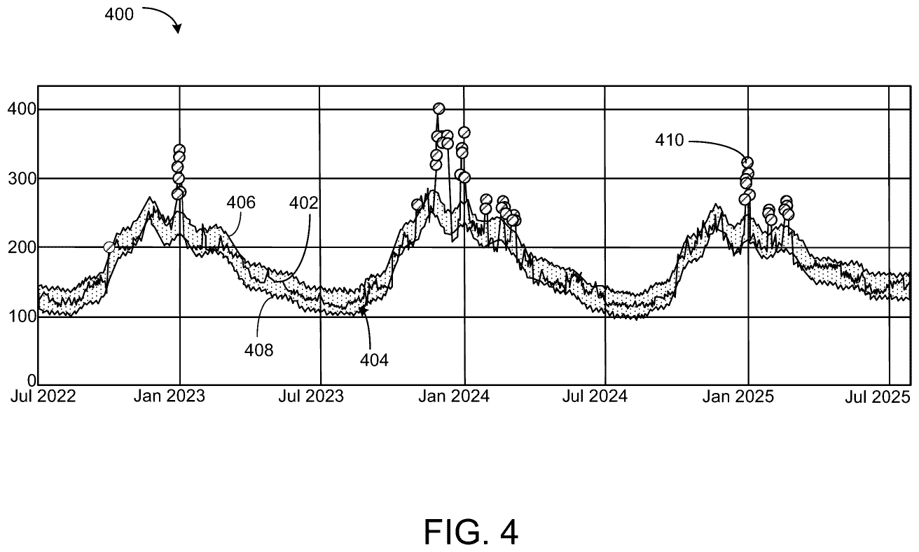

Subsequent to aggregating the data, the anomaly detector circuit 134 may plot the data as a function of time. An example plot is shown and described in greater detail with respect to FIG. 4. The anomaly detector circuit 134 may further identify a standard or “normal” data value for a particular market (e.g., geographic area) over the predefined period of time. As described herein, a normal value may be an average value for a provider over a particular time frame and/or when no external factors influence the data value(s). A normal value may be seasonal (e.g., a normal price for a lodging venue in July may be higher than a normal price for the same lodging venue in February).

To identify a normal value, the anomaly detector circuit 134 may generate a representative curve. The anomaly detector circuit 134 may generate the representative curve using a machine learning model. The model may use historical data from a plurality of providers to learn previous data points and trends and generate future predictions of data values and trends. The generated curve may generalize data for weekly and annual seasonality. For example, the anomaly detector circuit 134 may generate a curve that accounts for specific seasons (e.g., summer) having overall higher data values than other seasons (e.g., winter). Further, the generated curve may account for specific weeks (e.g., the week of Christmas) having overall higher data values than other weeks (e.g., a non-holiday week in March) and/or specific days of the week (e.g., Saturdays) having overall higher data values than other days of the week (e.g., Wednesdays). The anomaly detector circuit 134 may generate the curve to account for seasonality to prevent incorrectly identifying anomalous data points or outliers. For example, a curve that does not account for weekly and annual seasonality may identify every weekend and/or summer season in a dataset as being anomalous because data values are higher than “normal” data values in the winter seasons and/or weekdays.

As an example, the anomaly detector circuit 134 may generate a price curve using data from a plurality of lodging providers. The anomaly detector circuit 134 may account for seasonality and/or trends such that the generated price curve does not identify increased lodging prices in the summer (resulting from seasonality of vacations) as anomalous.

In various embodiments, the generated curve may identify, for each day, a representative value (e.g., a mean value indicating an average “normal” data value (e.g., a normal price)). The generated curve may further include a range of data values determined to be “normal” or standard. For example, the anomaly detector circuit 134 may identify an upper range value and a lower range value that indicate a range in which an average or representative data value for that date can fall in and still be considered a normal value (e.g., not an anomalous value). The upper and lower range values may be a certain threshold value above and below the representative (e.g., mean) value, respectively. The upper and lower range values may be set by determining a certain threshold value deviation from the representative (e.g., mean) value. For example, a range value may be defined as a value deviating a certain amount from the mean. Specifically, when a price curve is generated, an upper range value may be set as a value $50 above the mean value and a lower range value may be set as a value $50 below the mean value. Additionally, the range value may be set as a certain number of standard deviations from the representative (e.g., mean) value. For example, an upper range value may be set as a value 1.5 standard deviations above the mean value and a lower range value may be set as a value 1.5 standard deviations below the mean value. Further, in other embodiments, the range value may be set as a percentage from the representative (e.g., mean) value. For example, an upper range value may be set as a value 20% above the mean value and a lower range value may be set as a value 20% below the mean value. In various embodiments, the upper and lower range values may be set as different values. For example, an upper range limit may be 20% above the representative value and a lower range limit may be set as 10% below the representative value.

For example, the anomaly detector circuit 134 may identify that a mean value of the price curve is $140. The upper range value may be, for example, $168 (e.g., 20% greater than $140), and the lower range value may be $112 (e.g., 20% less than $140). The range of lodging prices may vary for each day in the predefined time period. The generated curve is shown and further described with respect to FIG. 4.

Upon generation of the curve, the anomaly detector circuit 134 may identify anomalous data points (e.g., outliers, anomalies, etc.) in the aggregated data relative to the determined range indicated by the generated representative curve. For example, for each day in the period of time, the anomaly detector circuit 134 may compare the value of the data in the aggregated data with the “normal” range of values in the generated curve. Upon comparing the data, the anomaly detector circuit 134 may determine whether the data point in the aggregated data falls within the identified normal range of values for that particular day. Responsive to a determination that the data point has a value greater than an upper range value of the representative curve (e.g., falls outside of the range), the anomaly detector circuit 134 may identify the data point as anomalous. Responsive to a determination that the data point has a value that falls within the upper limit value and lower limit value (e.g., falls within the range) of the representative curve, the anomaly detector circuit 134 may identify the data point as normal or not anomalous. Responsive to a determination that the data point has a value less than a lower range value of the representative curve, the anomaly detector circuit 134 may identify the data point as anomalous.

Accordingly, in some embodiments, the anomaly detector circuit 134 implements and/or utilizes high and/or low-pass filters to perform anomaly detection. For example, a low pass filter or similar circuit may identify a data point as anomalous when the data value is above a certain threshold value, and a high pass filter or similar circuit may identify a data point as anomalous when the data value is below a certain threshold value.

In various embodiments, the anomaly detector circuit 134 may identify a data point as anomalous by identifying a magnitude of discrepancy between the data point value and the upper (or, in some embodiments, lower) range limit value. For example, the anomaly detector circuit 134 may determine an absolute value of the difference between the data point from the aggregated data and the upper range limit from the generated curve. The deviation of the data point value from a mean or representative value of the curve data may be expressed as 100*|aggregated data value−mean curve value|. The deviation value may indicate the magnitude of the anomaly (e.g., a larger value output from the equation indicates a greater magnitude of deviation or a greater magnitude of the anomaly).

In various embodiments, the anomaly detector circuit 134 may determine that a data value from the aggregated data is an anomaly when the determined magnitude or deviation is greater than a certain threshold value. For example, the anomaly detector circuit 134 may identify a data point as anomalous based on a determination that the deviation is greater than or equal to a certain percentage of the upper range value or the mean curve value (e.g., the data point value is at least 20% higher than the upper range value), greater than or equal to a certain number of standard deviations above the upper range value or the mean curve value (e.g., the data point value is at least 1.5 standard deviations from the upper range value), a certain amount greater than the upper range value or the mean curve value (e.g., the data point value is $50 greater than the upper range value), etc.

In various embodiments, the anomaly detector circuit 134 may detect anomalies using a multi-pass approach. For example, the anomaly detector circuit 134 may perform two separate anomaly detections. Performing multiple anomaly detections may prevent anomalies from affecting general trend data (e.g., the generated curve) a disproportionate amount. As such, during a first pass, the anomaly detector circuit 134 may detect major outliers (e.g., data points having a deviation magnitude above a certain threshold value). Upon detection of such outliers, the anomaly detector circuit 134 may remove the outlier data points from the data set (e.g., from the aggregated data), and the anomaly detector circuit 134 may regenerate the curve (e.g., the anomaly detector circuit 134 may re-fit a trend to the aggregated data). Upon regeneration of the curve, the anomaly detector circuit 134 may perform a second anomaly detection to identify additional outliers. In various embodiments, the method of performing outlier detection may be the same for the first, second, and any additional anomaly detection passes. However, the threshold value for identifying a data value as an outlier or anomaly may vary. For example, during a first pass, the deviation magnitude threshold value may be 30%, 2 standard deviations, $75, etc. During a second pass, the deviation magnitude threshold value may be 20%, 1.5 standard deviations, $50, etc.

Performing a multi-pass anomaly detection may prevent certain events from affecting the generated curve. For example, certain events affecting lodging prices may include multi-day or week events, such as the Olympic Games, FIFA World Cup, or the United Nations Climate Change Conference. Notably, the aforementioned events may be non-repeating events due to changes in date and/or locations. Without a multi-pass anomaly detection, such events may cause the generated representative data curve (e.g., price curve in this example) to overestimate data values (e.g., prices) for similar time periods during years in which the event does not occur.

Identification of anomalous data points (e.g., during a second pass of anomaly detection) may indicate that an event is occurring in a geographic area that is causing data values (e.g., lodging prices) to be higher than normal. Such events may include, for example, sporting events (e.g., football games, basketball games, soccer matches, the Super Bowl, the World Cup, the Olympics, etc.), concerts, business conventions, political events (e.g., climate summit, political rallies, party conventions, etc.), astronomical or natural phenomena (e.g., solar eclipse, aurora borealis, etc.), festivals (e.g., Mardi Gras, Carnivale, etc.), religious events (Pope visits, etc.), etc. Upon identification of an anomaly, the anomaly detector circuit 134 may identify the date on which the anomaly occurs and a magnitude of the deviation from the mean value of the curve.

The anomaly detector circuit 134 and/or the model used to generate the curve may be updated periodically (e.g., every week, every month, every 24 hours, etc.) to account for updates in data retrieved by the retrieval circuit 132 and/or updates to data trends.

The event identification system or circuit 136 may be configured to identify at least one basis for the identified anomalies. For example, the event identification circuit 136 may identify one or more specific events causing the anomalies identified by the anomaly detector circuit 134. For example, detection of anomalies in the aggregated data by the anomaly detector circuit 134, may indicate to the event detector circuit 130 and/or cause the event detector circuit 130 to determine that there may be one or more events occurring in the geographic area of interest (e.g., the location where the lodging providers are located) that are causing data values (e.g., lodging prices, occupancy numbers, etc.) to be increased relative to a typical or normal value. However, the anomaly detector circuit 134 alone may not indicate what specific event or events are occurring in the area that are causing the data value increases. The event identification circuit 136 may therefore use the information from the anomaly detector circuit 134 (e.g., that one or more events may be occurring in the area) to identify specific events and information associated with the event(s) causing the anomalies, such as a name of the event, a type of the event, a specific location of the event, a date of the event, a time of the event, ticket sales date, etc.

Identifying events and corresponding information associated with the event(s) causing anomalies may cause the provider computing system 105 and/or third-party providers to initiate one or more actions. For example, an event causing the one or more anomalies may be identified as a concert occurring on a particular day, and the event information may indicate a date on which tickets for the concert go on sale. Upon receiving this information, the provider computing system 105 and/or the third-party providers may use the information (e.g., the ticket sales start date) to initiate actions relating to the services provided by the providers for the date(s) on which the event is occurring. For example, upon receiving an indication of a ticket sales start date for a concert, the provider computing system 105 and/or the third-party providers may begin marketing efforts, bidding, preparation of the supply of goods, etc. for the concert. The date on which such preparation begins may correspond to the ticket sales start date (e.g., marketing for a hotel Atty. proximate the location of the concert may begin on or around the date on which tickets for the concert go on sale).

The event identification circuit 136 may be or include the at least one machine learning model 138, also referred to as a large language model 138 or an LLM 138. For example, the event identification circuit 136 may generate a prompt for the LLM 138 that causes the LLM 138 to retrieve a list of events occurring in the geographic area over a certain period of time. Prompts may include, for example, a request for a list of events and data corresponding to the events. For example, the anomaly detector circuit 134 may perform anomaly detection to determine that an event is occurring on April 18 in Seattle, WA. The event identification circuit 136 may generate a prompt for the LLM 138 that prompts the LLM 138 to return a list of all events occurring in Seattle on April 18. As such, the prompt may read: “Provide a list of all events occurring in Seattle, WA, on April 18^{th}.” Prompts may include additional details. For example, a prompt may read: “Provide a list of the five largest events occurring within a ten mile radius of the Seattle Seahawks stadium on April 18 from 11 AM to 11 PM.” In some embodiments, the prompt may be specific to one or more certain types of event (e.g., concert, political event, sporting event, etc.). For example, a prompt may read: “Provide a list of all professional sporting events occurring within a fifteen mile radius of Seattle, WA between April 18 and April 20.” In various embodiments, the LLM 138 may not be updated for a most current list of events, and may therefore be grounded with external knowledge. As such, responsive to receipt of the prompt, the LLM 138 may return a ranked list of events occurring in the area on the identified date or dates.

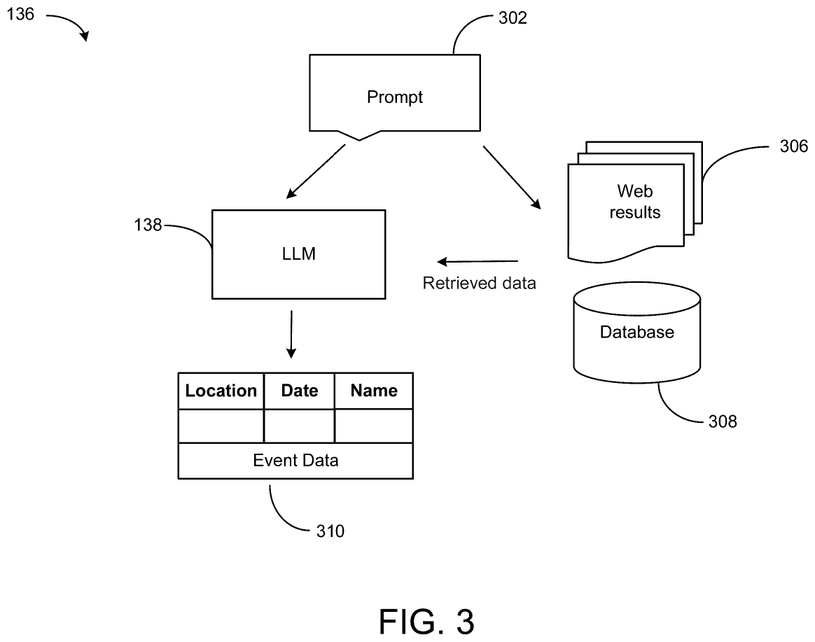

The LLM 138 may retrieve information from one or more predefined websites provided by the event identification circuit 136. For example, particularly when searching for concert events, the event identification circuit 136 may prompt or instruct the LLM 138 to find data from a ticket-providing website or event aggregator by scraping those sites. Further, in some embodiments, the LLM 138 may perform a web search to identify the list of events. Upon retrieval of such websites, the LLM 138 may be used to retrieve event data from the identified sources. In various embodiments, a retrieval augmented generation (RAG) architecture may be used. For example, a RAG architecture may be used so that the LLM 138 returns a list of events, each event listing including a name of the event, a category, a location, a name of the venue, geographic coordinates or a link to specific geographic coordinates of the event, etc. The LLM retrieval process is described in greater detail with respect to FIG. 3.

In various embodiments, the prompt provided to the LLM 138 by the event identification circuit 136 may be specific to prevent irrelevant events from being returned. Further, the prompt may be engineered such that minor events occurring in the geographical area that do not affect lodging prices (e.g., small, local events) are not included in the returned list. As such, an example prompt may read: “Provide a list of ten events occurring in Seattle, WA on April 18 that are expected to have the largest number of attendees.” In some implementations, prompts may be specific to types of events. For example, a prompt may read “Provide a list of major sporting events occurring in Europe in April.” In this way, the provider computing system may receive a list of events for a predefined time period. In some embodiments, the list may only include predefined major events (e.g., major sports, concerts, etc.) as compared to relatively less major events (e.g., weekly band-series at various local restaurants/venues). Based on the list of predefined major events, the provider computing system may receive information regarding dates of predefined major events for the time period. As such, in some implementations, a prompt to the LLM 138 may read, for example, “Provide a list of major events in Seattle, WA in April.” The LLM 138 may return a list of major events for a particular period of time (which may, in some embodiments, be provided to the LLM 138 via a prompt, or inferred by the LLM 138). The list of events may be combined or otherwise joined with a list of dates on which one or more anomalies have been identified by the anomaly detector circuit 134.

The event identification circuit 136 may identify, based on a match between one or more details of an event of the list of events (e.g., a date of an event) and details of at least one of the one or more detected anomalies (e.g., a date on which the anomaly occurs), an event occurring in the geographic area causing the anomaly. As used herein, a “match” may refer to a determination that one or more pieces of data and/or details regarding the anomalous data correspond to (e.g., are the same or similar) to details of an event on the list of events. For example, the anomalous data may indicate that lodging prices have increased on a certain day in a certain geographic region. The list of events may include, for each event, details including the location of the event, a duration of the event, a date of the event, etc.

In various embodiments, the event identification circuit 136 may cross-reference the identified one or more anomalies with the list of events to determine which event or events may be causing the changes in the received data. For example, the event identification circuit 136 may analyze the data received from each of the providers, as well as the event information retrieved from the LLM 138, to detect which specific event is causing a change in data (e.g., a price increase). For example, the anomaly detector circuit 134 may detect an anomaly in the data on a Sunday in September in Seattle, WA. The list of events may include a both a football game and a concert occurring in Seattle on that Sunday. The event identification circuit 136 may further analyze the data from each individual lodging provider, as well as the event information, to determine that lodging venues located closest to the football game venue (e.g., as indicated in the event information) are priced higher relative to other lodging venues in the area (e.g., including lodging venues located closer to the concert venue). The event identification circuit 136 may utilize this information to determine that the event causing the data anomaly is the football game. In some embodiments, the event identification circuit 136 and/or the LLM 138 may utilize additional information to make this determination. For example, the LLM 138 may further determine that the artist performing at the concert is a small, local artist unlikely to be causing an increase in travelers to Seattle, and therefore the football game is causing the data anomaly.

Accordingly, as described herein, the event identification circuit 136 may validate the basis for the one or more anomalies received from the LLM 138. Validation may prevent or reduce hallucination of the LLM 138. For example, the LLM 138 may identify a basis (e.g., an event) causing the one or more anomalies in the aggregated data set. Validation may be performed by the LLM 138. For example, the LLM 138 may identify that a basis for the detected anomalies is a concert being performed. To validate the identified basis, the LLM 138 may perform a search (e.g., using a search engine) to confirm that a concert is occurring in the geographic region on the particular date indicated by the basis and/or the anomaly.

In various embodiments, the event identification circuit 136 may utilize the determined event data to inform one or more users, travelers, vendors, vacation rental hosts, etc., of the data anomaly and corresponding event. That is, the event identification circuit 136 may notify a user regarding the basis identified by the LLM 138. For example, the event identification circuit 136, upon detection of an event causing an anomaly, may transmit and display a notification to a user booking travel. The notification may include a notice to a user explaining why prices are higher than expected for those specific dates (e.g., based on historical data). Notifications may be delivered to a user via the user device 140. Types of notifications may include, for example, a pop-up in the client application 145 after the user identifies a region of interest, an email after the user identifies a region of interest and a time or travel, a text message, a banner notification within the client application 145 that is specific to an identified region and/or time of travel but irrespective to the user (e.g., all users of the client application 145 receive the same notification), etc. For example, when searching for lodging, a notification may be displayed to the user that explains that lodging prices have increased because a concert for a popular artist is being held on those days the user is searching for. The notification may be generated and displayed responsive to a determination that the user is searching for lodging in the location where the event is occurring for the dates when the event is occurring. A notification may also be displayed to a user prompting the user to book a lodging venue because a price is expected to increase due to an upcoming event in the geographic area.

Further, the event identification circuit 136 may use the detected events to inform one or more travel lodging hosts, such as a vacation rental host. In various embodiments, vacation rental hosts may set less dynamic prices for properties relative to other lodging providers. For example, vacation rental hosts may set a single price for their vacation rental that does not update based on factors such as demand, events occurring in the area, seasonality, etc. As such, the event identification circuit 136 may, upon detection of an event, transmit a notification to one or more vacation rental hosts indicating that an event is occurring and suggesting that the host raise their vacation rental prices accordingly.

Referring now to FIG. 3, the event identification circuit 136 for identifying events is shown, according to an example embodiment. The event identification circuit 136 may be or include one or more components of the event detector circuit 130. Specifically, the event identification circuit 136 may include the LLM 138. The event identification circuit 136 may further include a prompt 302, web results 306, a database 308, and an event list 310.

The event identification circuit 136 may provide a prompt 302 to the LLM 138. As described above, the prompt 302 may include a prompt to the LLM 138 requesting a list of events to be returned for a particular location on a particular day. The prompt 302 may further specify certain search parameters, such as specific websites the LLM 138 is to search, a certain format to return the list in, etc.

Thus, the LLM 138 may utilize web results 306 and/or database 308 information. For example, upon receipt of the prompt 302, the LLM 138 may search web sites, such as ticket-providing sites, to retrieve web results 306 indicating concerts occurring in the geographic area during a specified period of time (e.g., a period of time including the day when an anomaly has been detected). The LLM 138 may also search or query a database 308 that is maintained by the provider and/or an external source to retrieve information used to detect events occurring.

Upon receipt of the web results 306 and the database 308 information, the LLM 138 may generate an event list 310. As shown, the event list 310 includes a location, a date, and a name of each event. In various embodiments, the event list 310 may include additional information, such as a category of the event. In various embodiments, the system 300 may prompt the LLM 138 to list all of the events identified via the web results 306 and the database 308 results, as well as details relating to each event, such as a name of the event, a location of the event, a date of the event, etc.

Referring now to FIG. 4, a graph 400 showing aggregated data with detected anomalies, according to an example embodiment. The provider computing system 105, and particularly the anomaly detector circuit 134, may generate the graph 400 to perform anomaly detection.

As shown, the graph 400 includes aggregated data 402. As described with respect to FIG. 2, the aggregated data 402 may include a plurality of representative data values among all providers for each period of time within the predefined time period. For example, in an embodiment where the graph 400 includes aggregated price data from a plurality of lodging providers, the aggregated data 402 includes an average price among all lodging providers for a room for a specific night. Further, the graph 400 includes a generated curve 404. The generated curve 404 may include an upper range value 406 and a lower range value 408. As described, the generated curve may have, for each day within the predefined time period, a determined representative (e.g., mean) data point value. The upper range value 406 and the lower range value 408 may be defined, for example, as being a certain number of standard deviations above the representative data value, above a certain percentage of the representative data value, above a certain value of the representative data value, etc.

The anomaly detector circuit 134 may identify one or more anomalies 410 in the aggregated data 402. As shown in the graph 400, an anomaly 410 is identified upon a determination that the data value for a particular day is greater than an upper limit value 406. The anomaly detector circuit 134 may identify such instances and transmit indications of the anomalies to the event identification circuit 136.

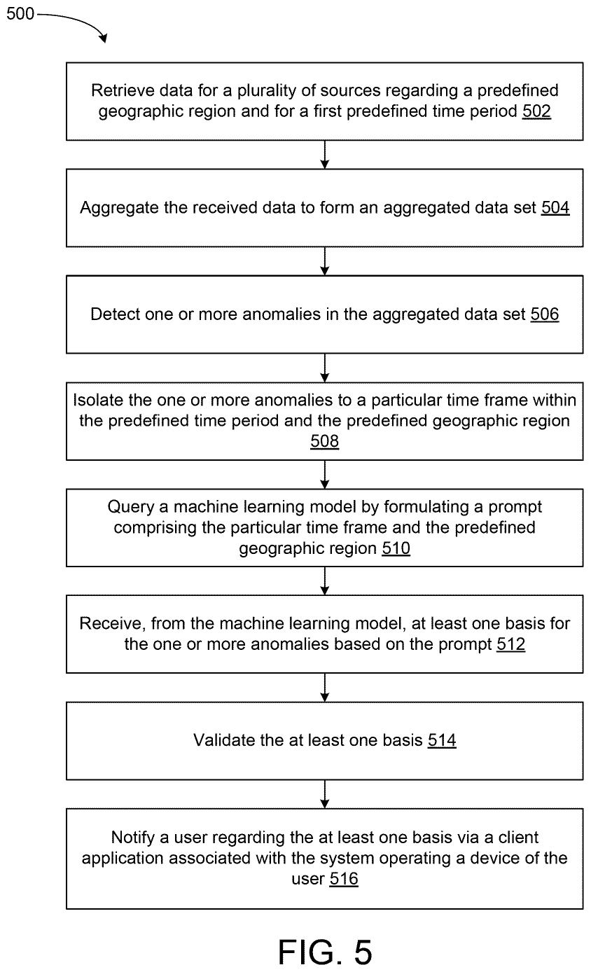

Referring now to FIG. 5, a flowchart of a method 500 for identifying events using aggregated data is shown, according to an example embodiment. The method 500 may be performed by one or more components of the system 100. In particular, various operations may be performed by the provider computing system 105, such as the event detector circuit 130. Operations may also be performed by the user device and/or third-party system 170. It should be understood that the order of operations may differ from what is depicted and operations may be added, deleted, or combined without departing from the scope of the method 500.

At process 502, the provider computing system 105 and particularly the retrieval circuit 132 receives, obtains, acquires, and/or retrieves data from a plurality of sources. The data may be received, for example, from a plurality of third-party computing systems 170. The retrieval circuit 132 may receive the data by, for example, initiating a plurality of API calls to a plurality of data sources. Each API call may include a request for specific information, such as a certain type or types of data, a time period from which the data should be, identifiers associated with the data, etc. In other embodiments, the retrieval circuit 132 may retrieve data that is stored in one or more databases of the system 100.

The received data may be filtered such that only specific data is used in subsequent processes of the method 500 (e.g., thereby reducing computing power, increasing processing times, etc.). For example, the retrieval circuit 132 filters the received data such that only data from specific sources (e.g., third-party providers) and/or specific types of sources are utilized. Similarly, the retrieval circuit 132 may filter the received data such that only data regarding one or more predefined geographic regions and/or for a first predefined time period is utilized. For example, the retrieval circuit 132 may transform the data to associate the data with a particular location (e.g., a zip code, coordinates, etc.). The data may be filtered such that data from a predefined time period is included in the data set.

Specifically, in one example, the retrieval circuit 132 retrieves price data for a plurality of lodging venues (e.g., hotels) in a predefined geographic region (e.g., a certain city of interest). The retrieval circuit 132 may retrieve data for a specified, predefined period of time (e.g., 180 days). The predefined period of time may include a historical period (e.g., past dates) and a future period (e.g., future dates). The retrieval circuit 132 may receive data from each lodging venue provider for each day of the period of time.

At process 504, the provider computing system 105 and particularly the anomaly detector circuit 134 aggregates the received data from process 502 to form an aggregated data set. For example, the anomaly detector circuit 134 may analyze the received data to determine summary or representative values for the aggregated data. For example, the anomaly detector circuit 134 determines a mean value using the retrieved data from all of the providers. Thus, the anomaly detector circuit 134 may determine a mean value for each period of time within the first predefined time period. For example, the aggregated data set may be for a predefined time period of 365 days. The anomaly detector circuit 134 may determine a mean value for each day within the predefined time period of 365 days that is representative of all of the aggregated data for each day.

In various embodiments, process 504 includes categorizing the received data. For example, the anomaly detector circuit 134 may receive data from a plurality of data sources. The anomaly detector circuit 134 may categorize and/or filter the received data to sort the data according to a specific metric. For example, the anomaly detector circuit 134 may receive, via the plurality of API calls, data from a variety of sources within the predefined geographic region. The anomaly detector circuit may sort and/or categorize the data to determine a specific location within the predefined geographic region that each data point came from. For example, the retrieval circuit 132 may initiate a plurality of API calls requesting data from the greater Seattle metropolitan area. The anomaly detector circuit 134 may sort the received data to identify specific locations within the Seattle metropolitan area from which each receive piece of data originated. For example, the anomaly detector circuit 134 may sort the data to determine specific neighborhoods the data originated from, to determine specific vendors and/or providers the data originated from, etc.

In some embodiments, the retrieval circuit 132 initiates a plurality of API calls to data sources located beyond the predefined geographic region. The anomaly detector circuit 134 may then categorize and/or filter the data to identify data from sources within the predefined geographic region. For example, the retrieval circuit 132 may initiate a plurality of API calls requesting data from any major metropolitan area in the United States. Upon receiving the data, the anomaly detector circuit 134 may sort the data to identify which metropolitan area each piece of data originated from. The anomaly detector circuit 134 (and/or, in some embodiments, the retrieval circuit 132) may remove data from the aggregated data set that does not originate from the predefined geographic region. For example, the predefined geographic region may be the Seattle metropolitan area. The anomaly detector circuit 134 may identify which pieces of data originated from the Seattle area and remove and/or not include any pieces of data that originated from other areas (e.g., the New York City metropolitan area, the Chicago metropolitan area, etc.) in the aggregated data set.

At process 506, the provider computing system 105 and particularly the anomaly detector circuit 134 detects one or more anomalies in the aggregated data set. An identified anomaly refers to a deviation of one or more data points from aggregated data set by more than a predefined value (e.g., amount, etc.). The deviation or anomaly may be used by the provider computing system 105 to determine and identify an event is occurring in the predefined geographic region causing prices (or another parameter, such as demand) to be higher than is typical for the day (e.g., based on historical data). The anomaly detector circuit 134 detects the one or more anomalies in the aggregated data set by applying a filter. The filter identifies data values within the data set that deviate by more than a predefined value from a representative data value of the aggregated data set.

For example, detecting the one or more anomalies at process 506 may include determining, by the anomaly detector circuit 134, a plurality of representative data values within the aggregated data set. Each representative data value may correspond to a period of time (e.g., a day) within the predefined time period (e.g., 180 days). Each representative data value may be, for example, an average data value. The anomaly detector circuit 134 may fit the representative data values to a representative curve to determine a range of data. The range of data may be indicative of expected data values (e.g., price per night at a hotel) at each period of time (e.g., each day) within the first predefined time period. For example, an upper limit of the range may indicate a highest expected data value and a lower limit of the range may indicate a lowest expected data value.

The anomaly detector circuit 134 may then determine that a deviating data value for one or more dates within the first specified time period is at or above a first predefined threshold value. The first predefined threshold value may be an upper limit of the range of data. In some examples, a deviating data value may be a representative data value, and the representative data value/deviating data value may exceed an upper or lower value of the range. Responsive to determining that the deviating data value is at or above the first predefined threshold value, the anomaly detector circuit 134 may identify the deviating data value for that period of time as anomalous.

In various embodiments, the anomaly detector circuit 134 may identify anomalies by performing a multi-pass anomaly detection. As such, detecting the one or more anomalies in the aggregated data may include, prior to determining that the deviating data value for one or more periods of time within the predefined time period is at or above the first predefined threshold value, determining that a deviating data value for one or more periods of time within the predefined time period is at or above a second predefined threshold value. The second predefined threshold value is greater than the first predefined threshold value. As such, during a first pass of anomaly detection, the anomaly detector circuit 134 may identify anomalies that may strongly influence the determined range of data.

The first and second predefined threshold values may be based on at least one of: the deviating data value being above an upper value of the range of data, the deviating data value being a certain number of standard deviations above the representative data value, or the deviating data value being a percentage above an upper value of the range of data.

At process 508, the provider computing system 105 and particularly the anomaly detector circuit 134 isolates the one or more anomalies to a particular time frame within the predefined time period and the predefined geographic region. For example, the anomaly detector circuit 134 isolates the one or more anomalies to the period of time. For example, the anomaly detector circuit 134 detects anomalies occurring on a specific date within the predefined time period. Similarly, the anomaly detector circuit 134 isolates the one or more anomalies to the predefined geographic region.

At process 510, the provider computing system 105 and particularly the event identification circuit 136 queries a machine learning model (e.g., the LLM 138). The event identification circuit 136 queries the machine learning model by formulating a prompt. The prompt may include the particular time frame and the predefined geographic region.

At process 512, the provider computing system 105 and particularly the event identification circuit 136 receives, from the machine learning model 138, at least one basis for the one or more anomalies based on the prompt. A basis for the one or more anomalies may be, for example, an event occurring in the geographic region that is causing the one or more anomalies to occur. For example, the at least one basis may be a list of events occurring in the geographic region during the same or similar particular time frame as the one or more anomalies. The machine learning model 138 may then, in some embodiments, compare the list of events with the detected one or more anomalies (e.g., the event identification circuit 136 may cross-reference the list of events with the detected anomalies) and identify one or more similarities between the anomalies and the list of events, such as a particular geographic location, a date, etc. to determine that one or more events is causing the identified anomaly or anomalies.

At process 514, the provider computing system 105 and particularly the event identification circuit 136 and/or the LLM 138 validates the at least one basis. Validating the at least one basis may include, for example, comparing one or more parameters of the at least one basis (e.g., event information such as a location, a time, a date, etc.) to one of more parameters of the one or more anomalies (e.g., a date or the particular time frame of the one or more anomalies). In some implementations, validating the at least one bias may prevent or reduce hallucinations of the LLM 138. Validating the bias may also include performing a search to compare the identified bias to a ground truth.

At process 516, the provider computing system 105 and particularly the event identification circuit 136 notifies a user regarding the at least one basis via a client application associated with the system operating a device of the user. For example, the event identification circuit 136 provides a notification to a user indicating that the bias is causing the one or more anomalies to occur.

The method 500 may further include determining an adjustment of a value for at least one of the plurality of data sources within the particular time frame. For example, the event detector circuit 130 may determine a magnitude of the event (e.g., basis) causing the anomaly by identifying an amount by which the deviating data value exceeds the first predefined threshold value for the date corresponding to the date of the event causing the anomaly. Further, the event detector circuit 130 may determine a magnitude of an adjustment of a value that corresponds to the determined magnitude of the basis for the one or more anomalies. For example, the anomaly detector circuit 134 may identify a magnitude of the basis based on a magnitude of a deviation of the deviating data value from the predefined first threshold value.

As a specific example, the event identification circuit 136 may reprice a lodging venue based on a magnitude of the deviation. For example, the event identification circuit 136 may price a hotel higher when the Super Bowl is occurring versus when a regular football game is occurring because the magnitude of deviation associated with the anomaly indicative of the Super Bowl is greater than a magnitude of deviation associated with the anomaly indicative of the regular football game.

In some embodiments, determining an adjustment of the data value includes identifying a location of the event causing the anomaly, and determining an adjustment magnitude of a value for each of the plurality of locations according to a distance of each location from the location of the event causing the anomaly. For example, a concert may be occurring at an arena. The event identification circuit 136 may price lodging venues closer to the arena higher than lodging venues further away from the arena.

The method 500 may further include transmitting a notification to a location provider. The notification may include a recommendation to adjust a value associated with the location for the date of the event causing the anomaly. For example, the event identification circuit 136 may transmit a notification to a vacation rental host indicating that an event is occurring and the price of the vacation rental should be accordingly increased.

The method 500 may further include transmitting a notification to a user selecting a location. The notification may include an indication that a value associated with a location is due to the event causing the anomaly. For example, when a user is searching for lodging, the event identification circuit 136 may display a notification to the user indicating that lodging prices are priced in such a way due to an event occurring on those dates in the geographic area.

As described herein, the systems, methods, and computer-readable media discuss methods for improved analysis of large data sets. For example, received data can be filters to isolate data that is relevant to the type of analysis being performed. As such, as described herein, data may be filtered according to an associated location and/or an associated timeframe. Advantageously, the methods of data analysis described herein also reduce computing power used to detect anomalies and provide improved methods, using machine learning models, of identifying and/or assigning meaning to identified anomalies in a large data set.

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The implementations described herein have been described with reference to drawings. The drawings illustrate certain details of specific implementations that implement the systems, methods, and programs described herein. Describing the implementations with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. In a non-limiting example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more processors, ASICs, FPGAs, GPUs, TPUs, digital signal processors (DSPs), or other suitable electronic data processing components structured to execute instructions provided by memory. The one or more processors may take the form of a single core processor, multi-core processor (e.g., a dual core processor, triple core processor, or quad core processor), microprocessor, etc. In some implementations, the one or more processors may be external to the apparatus, in a non-limiting example, the one or more processors may be a remote processor (e.g., a cloud-based processor). Alternatively or additionally, the one or more processors may be internal or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the implementations might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard disks, optical disks, etc. In other implementations, the volatile storage media may take the form of RAM, TRAM, ZRAM, etc. Combinations of the above are also included within the scope of machine-readable media. In this regard, machine-executable instructions comprise, in a non-limiting example, instructions and data, which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

While this specification contains many specific implementation details, these should not be construed as limitations on the scope of any arrangements or of what may be claimed, but rather as descriptions of features specific to particular implementations of the systems and methods described herein. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementations,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions, and implementation of the implementations without departing from the scope of the present disclosure as expressed in the appended claims.

1. A system for detecting and identifying data anomalies, the system comprising:
at least one processing circuit comprising one or more processors coupled to one or more memory devices, the at least one processing circuit configured to:
receive data from a plurality of sources regarding a predefined geographic region and for a first predefined time period;
aggregate the received data to form an aggregated data set;
detect one or more anomalies in the aggregated data set by analyzing the aggregated data set by applying a filter that identifies data values within the aggregated data set that deviate by more than a predefined value from a representative data value of the aggregated data set, wherein applying the filter comprises:
determining a plurality of representative data values, each representative data value corresponding to a period of time within the predefined time period;
fitting the plurality of representative data values to a curve to determine a range of data, the range of data indicative of a range of expected data values at each period of time within the predefined time period;
determining a deviating data value for a period of time within the predefined time period based on the deviating data value being at or above a first predefined threshold value; and
responsive to determining that the deviating data value is at or above the first predefined threshold value, identifying the deviating data value for the period of time as an anomaly of the one or more anomalies;
isolate the one or more anomalies to a particular time frame within the predefined time period and the predefined geographic region;
query a machine learning model by formulating a prompt comprising the particular time frame and the predefined geographic region;
receive, from the machine learning model, at least one basis for the one or more anomalies based on the prompt;
validate the at least one basis; and
notify a user regarding the at least one basis via a client application associated with a system operating a device of the user.

2. (canceled)

3. The system of claim 1, wherein detecting the one or more anomalies in the aggregated data set further comprises:
prior to determining that the deviating data value for the period of time within the predefined time period is at or above the first predefined threshold value, determining that the deviating data value for the period of time within the predefined time period is at or above a second predefined threshold value, wherein the second predefined threshold value is greater than the first predefined threshold value.

4. The system of claim 3, wherein the first and second predefined threshold values are based on at least one of: the deviating data value being above an upper value of the range of data, the deviating data value being a certain number of standard deviations above the representative data value, or the deviating data value being a percentage above an upper value of the range of data.

5. The system of claim 1, wherein validating the at least one basis comprises comparing one or more parameters of the at least one basis to one or more parameters of the one or more anomalies.

6. The system of claim 1, wherein the at least one processing circuit is further configured to:
determine an adjustment of a data value for at least one of the plurality of data sources within the particular time frame.

7. The system of claim 6, wherein determining the adjustment of the value comprises:
determining a magnitude of the basis for the one or more anomalies by identifying an amount by which the deviating data value exceeds the first predefined threshold value; and
determining a magnitude of the adjustment of the value that corresponds to the determined magnitude of the basis for the one or more anomalies.

8. A method for detecting and identifying data anomalies, the method comprising:
receiving, by one or more processors, data from a plurality of sources regarding a predefined geographic region and for a first predefined time period;
aggregating, by the one or more processors, the received data to form an aggregated data set;
detecting, by the one or more processors, one or more anomalies in the aggregated data set by analyzing the aggregated data set by applying a filter that identifies data values within the aggregated data set that deviate by more than a predefined value from a representative data value of the aggregated data set, wherein applying the filter comprises:
determining a plurality of representative data values, each representative data value corresponding to a period of time within the predefined time period;
fitting the plurality of representative data values to a curve to determine a range of data, the range of data indicative of a range of expected data values at each period of time within the predefined time period;
determining a deviating data value for a period of time within the predefined time period based on the deviating data value being at or above a first predefined threshold value; and
responsive to determining that the deviating data value is at or above the first predefined threshold value, identifying the data value for the period of time as an anomaly of the one or more anomalies;
isolating, by the one or more processors, the one or more anomalies to a particular time frame within the predefined time period and the predefined geographic region;
querying, by the one or more processors, a machine learning model by formulating a prompt comprising the particular time frame and the predefined geographic region;
receiving, by the one or more processors, from the machine learning model, at least one basis for the one or more anomalies based on the prompt;
validating, by the one or more processors, the at least one basis; and
notifying, by the one or more processors, a user regarding the at least one basis via a client application associated with a system operating a device of the user.

9. (canceled)

10. The method of claim 8, wherein detecting the one or more anomalies in the aggregated data set further comprises:
prior to determining that the deviating data value for the period of time within the predefined time period is at or above the first predefined threshold value, determining that the deviating data value for the period of time within the predefined time period is at or above a second predefined threshold value, wherein the second predefined threshold value is greater than the first predefined threshold value.

11. The method of claim 10, wherein the first and second predefined threshold values are based on at least one of: the deviating data value being above an upper value of the range of data, the deviating data value being a certain number of standard deviations above the representative data value, or the deviating data value being a percentage above an upper value of the range of data.

12. The method of claim 8, wherein validating the at least one basis comprises comparing one or more parameters of the at least one basis to one or more parameters of the one or more anomalies.

13. The method of claim 8, wherein the method further comprises:
determining an adjustment of a data value for at least one of the plurality of data sources within the particular time frame.

14. The method of claim 13, wherein determining the adjustment of the value comprises:
determining a magnitude of the basis for the one or more anomalies by identifying an amount by which the deviating data value exceeds the first predefined threshold value; and
determining a magnitude of the adjustment of the value that corresponds to the determined magnitude of the basis for the one or more anomalies.

15. One or more non-transitory computer-readable media storing instructions thereon that, when executed by one or more processors, cause the one or more processors to perform operations comprising:
receiving data from a plurality of sources regarding a predefined geographic region and for a first predefined time period;
aggregating the received data to form an aggregated data set;
detecting one or more anomalies in the aggregated data set by analyzing the aggregated data set by applying a filter that identifies data values within the aggregated data set that deviate by more than a predefined value from a representative data value of the aggregated data set, wherein applying the filter comprises:
determining a plurality of representative data values, each representative data value corresponding to a period of time within the predefined time period;
fitting the plurality of representative data values to a curve to determine a range of data, the range of data indicative of a range of expected data values at each period of time within the predefined time period;
determining a deviating data value for a period of time within the predefined time period based on the deviating data value being at or above a first predefined threshold value; and
responsive to determining that the deviating data value is at or above the first predefined threshold value, identifying the deviating data value for the period of time as an anomaly of the one or more anomalies;
isolating the one or more anomalies to a particular time frame within the predefined time period and the predefined geographic region;
querying a machine learning model by formulating a prompt comprising the particular time frame and the predefined geographic region;
receiving, from the machine learning model, at least one basis for the one or more anomalies based on the prompt;
validating the at least one basis; and
notifying a user regarding the at least one basis via a client application associated with a system operating a device of the user.

16. (canceled)

17. The non-transitory computer-readable media of claim 15. wherein detecting the one or more anomalies in the aggregated data set further comprises:
prior to determining that the deviating data value for the period of time within the predefined time period is at or above the first predefined threshold value, determining that the deviating data value for the period of time within the predefined time period is at or above a second predefined threshold value, wherein the second predefined threshold value is greater than the first predefined threshold value.

18. The non-transitory computer-readable media of claim 17, wherein the first and second predefined threshold values are based on at least one of: the deviating data value being above an upper value of the range of data, the deviating data value being a certain number of standard deviations above the representative data value, or the deviating data value being a percentage above an upper value of the range of data.

19. The non-transitory computer-readable media of claim 15, wherein validating the at least one basis comprises comparing one or more parameters of the at least one basis to one of more parameters of the one or more anomalies.

20. The non-transitory computer-readable media of claim 15, wherein the instructions further cause the one or more processors to perform operations comprising:
determining an adjustment of a data value for at least one of the plurality of data sources within the particular time frame by:
determining a magnitude of the basis for the one or more anomalies by identifying an amount by which the deviating data value exceeds the first predefined threshold value; and
determining a magnitude of the adjustment of the value that corresponds to the determined magnitude of the basis for the one or more anomalies.
